(19) United States
(12) Patent Application Publication
(10) Pub. No.: US 2018/0307745 A1
(43) Pub. Date: Oct. 25, 2018

(54) DETERMINING IF AN ACTION CAN BE PERFORMED BASED ON A DIALOGUE

(71) Applicant: Digital Genius Limited, London (GB)

(72) Inventors: YORAM BACHRACH, LONDON (GB); PAVEL MINKOVSKY, BELMONT, CA (US)

(73) Assignee: Digital Genius Limited, London (GB)

(21) Appl. No.: 15/877,016

(22) Filed: Jan. 22, 2018

(30) Foreign Application Priority Data
Apr. 25, 2017 (GB) 1713746.4

(51) Int. Cl. G06F 17/30; G10L 15/22; G10L 15/16; G06F 17/27; G10L 15/18

(52) U.S. Cl. CPC G06F 17/30654; G10L 15/22; G10L 15/1822; G06F 17/279; G10L 15/16

(57) ABSTRACT

A method comprises: receiving input of a dialogue; processing the dialogue by a neural network based system, to output, for each of a plurality of slots, a probability distribution over a range of values associated with the respective slot, the neural network based system being trained using a training dataset comprising a plurality of dialogues and, for each dialogue, a value corresponding to each slot, wherein each dialogue resulted in an action; determining, based at least on the probability distribution for each slot, if an action requiring one of values for at least some of the slots can be performed; if not, causing continuing of the dialogue.

### FIELD OF THE INVENTION

The invention relates to a method of determining if an action requiring values can be performed based on a dialogue, in particular where the action is a routine invokable by an API call and where the dialogue is between a user and an automated agent, such as a chatbot. The invention also relates to a related system and computer program product. The invention also relates to a method of automatically determining a state structure for a dialogue tracking system, together with a related system and computer program product.

### BACKGROUND

Dialogue systems, sometimes called conversational agents, are systems designed to converse with humans in natural language in a coherent way, typically in order to help the user achieve some goal. Uses of such systems include responding to customer questions, replying to queries regarding a knowledge base, automating help desk functions or providing technical support or training and education.

Conversational agents that both converse with users and autonomously take actions on their behalf are particularly challenging to build. One method for designing such conversational agents is though statistical dialogue systems, which maintain a distribution over multiple hypotheses regarding correct state of the dialogue, so as to be robust to complex requests by users stated using utterances that may be noisy or ambiguous. Quality of tracking of a correct dialogue state at different points in a conversation has a strong impact on achieving a high system-wide performance Dialogue systems comprise a dialogue state tracker (DST), which infers a user's intentions as a conversation progresses. DST systems represent the user's intention at a point in a conversation as a belief-state, composed of a set of slot-value pairs. Assigning a specific value to a slot reflects a constraint or requirement a user has.

For example, an automated subscription management system may allow creating, freezing or canceling subscriptions to various magazines, such as Sports, Arts or Science magazines. In this case, a person may have subscriptions to any subset of the magazines, and a subscription can be frozen for a month, a quarter (three months) or a whole year (assuming that a created subscription lasts until canceled, and that once a subscription is canceled, no magazines are sent until the user creates a new subscription). Thus, a conversational agent talking to a customer has to determine which action the user wants to take (create, freeze or cancel), which magazine they want to take the action on (Sports, Arts or Science); in the case of freezing a subscription, the agent must also determine the duration (a month, quarter or a year). A DST system for the above example domain might include three allowed actions: Create, Freeze, Cancel. Further, it is reasonable to track two slots: a Magazine slot (which can take the values Sports, Arts or Science), and a Duration slot (which can take the values Month, Quarter, Year, depending on how long the user wants to freeze the subscription for). The list of slots and the possible values each can take are referred to as the state-structure. This example is referred to throughout.

It is an object of the present invention to provide a way to automatically take actions based on dialogue.

### SUMMARY OF THE INVENTION

An example conversation, along with the desired belief-state that a DST would ideally output at every point in the conversation, is provided in FIG. 1. Actions taken on the external subscription management system are also listed (represented as routine calls to the external system). The left side shows the conversation text itself (chat log) along with the executed actions, and the right side shows the desired belief-state to be outputted by the DST system.

A big shortcoming of the current approach for building DST systems is the lack of labelled data. Many firms do typically store historical logs of past conversations between human agents and customers. However, these conversations do not come annotated with the correct belief state at every point in the conversation. In order to get training data to build the DST, researchers have proposed using a Wizard-of-Oz approach. In this approach, a human domain expert first examines the historical chat logs to identify key slots to track through the conversation, and the values that these slots may take; the domain expert then constructs the full state-structure for the DST. Then, human annotators are asked to examine each conversation in the historical chat logs; they are asked to provide the belief-state at every point in each such conversation, under the state-structure specified by the domain expert. Such annotations are indicated on the right in FIG. 1.

The above described approach is referred to as a “tight supervision” approach, as the machine learning system gets a supervision signal at every point in every conversation in the training set. As this tight supervision approach requires annotations to be done manually, it is very costly and does not scale. Furthermore, it restricts DST models from being easily generalizing across different domains.

In accordance with a first aspect of the present invention, there is provided a method comprising: receiving input of a dialogue; processing the dialogue by a neural network based system, to output, for each of a plurality of slots, a probability distribution over a range of values associated with the respective slot, the neural network based system being trained using a training dataset comprising a plurality of dialogues and, for each dialogue, a value corresponding to each slot, wherein each dialogue resulted in an action; determining, based at least on the probability distribution for each slot, if an action requiring a values for at least some of the slots can be performed; if not, causing continuing of the dialogue.

Thus, where the neural network based system is trained with such a dataset, it can be determined whether an action can be performed, for example a routine executed, based on the dialogue, and if the action cannot be performed, the dialogue system can be instructed to continue the dialogue. The method may be applied for each utterance input by a user.

The need to annotate training datasets is thus avoided.

The determining if the action can be performed may comprise: determining, for each slot, if one of the values can be selected based at least on the probability distribution and at least one selection criterion; determining if the action can be performed at least based also on a result of the determining if one of the values can be selected for each slot.

The method may further comprising: for each of the slots for which a value can be selected, selecting the value for the slot; and if the required values are selected, causing the action to be performed using the selected values.

For each slot, if a result of the determining is that no value can be selected for a slot, an indication that no value can be selected may be associated with the slot.

The selecting the values for the slots may comprise selecting the mode value of the probability distribution for the respective slot.

The at least one selection criterion may comprise determining if the probability distribution indicates that a probability score for the mode value meets a requirement for the extent to which the probability score for the mode value is greater than the probability score for other of the values.

The at least one selection criterion may comprise: determining, for each slot, a prior distribution of the values for that slot in the training dataset; determining, for each slot, a divergence value indicative of divergence of the probability distribution from the prior distribution; comparing the divergence value to a predetermined threshold value; determining that one of the values can be selected based on a result of the comparing.

The determining, for each slot, the divergence value, may comprise evaluating the Kullback-Leibler divergence between the prior distribution and the probability distribution.

According to the method, the action may have parameters, and each slot may correspond to a respective one of the parameters.

The determining if an action requiring at least some of the values can be performed may comprise determining if a value is selected for each of the slots.

The action may comprise an API routine.

The training dataset may comprise API calls data comprising the plurality of dialogues, for each dialogue, information indicative of each parameter, and, for each parameter a respective value, each of the values was recorded by a human agent when such a value was known to the human agent from the corresponding dialogue, and the human agent invoked an API call to the corresponding routine.

The neural network based system may comprise a recurrent neural network component and, for each slot, a respective classifier, wherein the processing the input dialogue comprises: generating word representation vectors for the dialogue; inputting the vectors into the recurrent neural network component, and outputting a further vector for each slot; processing, for each slot, the respective further vector, using the respective classifier, to generate the probability distribution for the values of the respective slot.

The determining, for each slot, if an action requiring at least one of the values can be performed may comprise: inputting a selected value or an indication that a value cannot be selected for each slot to a decision module; determining, by the decision module, to perform at least one of: causing the action to be performed, and the causing continuing of the dialogue by a non-person agent.

The method may comprise: determining, using the training dataset, the slots; determining possible values for each of the slots; setting the determined values for each slot as a range for that slot.

The method may further comprise: trained the neural network based system using the training dataset comprising a plurality of dialogues and, for each dialogue, the value corresponding to each slot, wherein each dialogue resulted in the action in the form of an API call invocation.

According to a second aspect of the present invention, a system may comprise: a neural network based system configured to: receive input of a dialogue; process the dialogue by a neural network based system; output, for each of a plurality of slots, a probability distribution over a range of values associated with the respective slot, the neural network based system being trained using a training dataset comprising a plurality of dialogues and, for each dialogue, a value corresponding to each slot, wherein each dialogue resulted in an action; a decision module configured to: determine, based at least on the probability distribution for each slot, if an action requiring a value for at least some of the slots can be performed; if not, causing continuing of the dialogue.

According to a third aspect of the present invention, a computer program product comprising computer program code stored on a computer readable storage medium, wherein, the computer program code is configured to, when run on a processing unit, perform the steps of: receiving input of a dialogue; processing the dialogue by a neural network based system, to output, for each of a plurality of slots, a probability distribution over a range of values associated with the respective slot, the neural network based system being trained using a training dataset comprising a plurality of dialogues and, for each dialogue, a value corresponding to each slot, wherein each dialogue resulted in an action; determining, based at least on the probability distribution for each slot, if an action requiring a value for at least some of the slots can be performed; if not, causing continuing of the dialogue.

In accordance with a fourth aspect of the present invention, there is provided a method of determining a state structure for API calls to a predetermined API, comprising: determining one or more slots of an API using past API calls data, wherein the API calls data comprises information indicative of one or more slots and a plurality of values for the or each of the parameters; determining a plurality of possible values for the or each slot; setting the determined values for each slot as a range for that slot.

The API calls data may comprise one or more parameters for an API, wherein the or each slot corresponds to a respective parameter, wherein the API calls data represents the one or more parameters and the plurality of values for the or each slot in a first format, the method further comprising converting the API call data to a second format, wherein the determining the one or more slots of the API and the plurality of possible values for the or each slot is performed using the API calls data in the second format.

The converting may comprise: inputting each API call in the first format using a trained neural network (RNN) based on a sequence-to-sequence model; processing each API call in the first format by the neural network and outputting each API call in the second format.

The trained neural network may comprise a recurrent neural network having an encoder-decoder architecture. The creating of the slot for each parameter and the setting of the determined values for each slot is performed using a parsing function.

In accordance with a fifth aspect of the present invention, there is provided a system for determining a state structure for API calls to a predetermined API, comprising: a determining unit configured to: determine one or more slots of an API using past API calls data, wherein the API calls data comprises information indicative of one or more slots and a plurality of values for the or each of the parameters; determine a plurality of possible values for the or each slot; set the determined values for each slot as a range for that slot.

In accordance with a sixth aspect of the present invention, there is provided a computer program product comprising computer program code stored on a computer readable storage medium, wherein, the computer program code is configured to, when run on a processing unit, perform the steps of: comprising: determining one or more slots of an API using past API calls data, wherein the API calls data comprises information indicative of one or more slots and a plurality of values for the or each of the parameters; determining a plurality of possible values for the or each slot; setting the determined values for each slot as a range for that slot.

### BRIEF DESCRIPTION OF THE FIGURES

For better understanding of the present invention, embodiments will now be described, by way of example only, with reference to the accompanying Figures in which:

FIG. 1 shows a dialogue with manually provided belief states indicated for each utterance in the dialogue;

FIG. 2 shows illustratively an example of conversion of an API calls dataset in a first format to an API calls dataset in a canonised format in accordance with embodiments;

FIG. 3 shows illustratively an architecture of a sequence-to-sequence model for use in the conversion;

FIG. 4 is a flowchart indicating steps in a process of extracting a state structure from an example API calls dataset, in according with embodiments of the invention;

FIG. 5 shows illustratively an architecture of a dialogue state tracking (DST) system in according with embodiments;

FIG. 6 is a flowchart indicating steps that take place in the DST system and a strategy network in accordance with embodiments;

FIG. 7 shows illustratively an architecture of a strategy network in accordance with embodiments of the invention;

FIG. 8 illustrates a comparison between tight supervision, as known from prior art, and loose supervision in accordance with embodiments of the invention;

FIG. 9 shows diagrammatically components in an example computing device on which embodiments of the invention may be implemented.

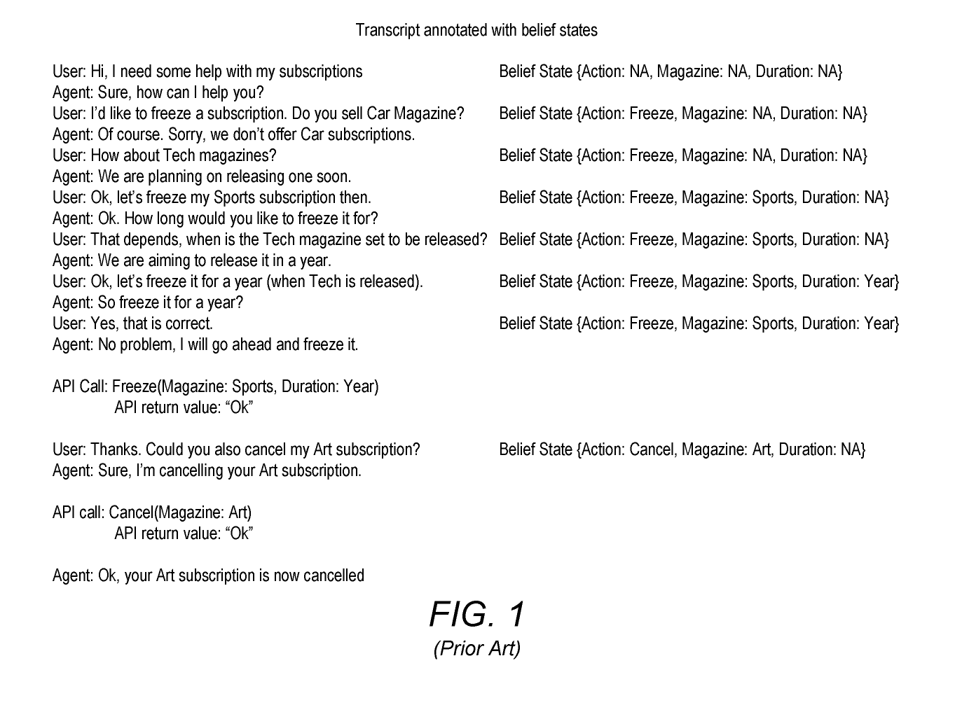

### DETAILED DESCRIPTION OF EMBODIMENTS

Embodiments of the invention relate to a system configured to automatically determine values required to perform an action, and to determine whether the values required for the action have been automatically determined. Actions in the form of routines that can be caused to be performed by invocation of API calls to an external system are referred to herein, but embodiments of the system are not limited to such. Embodiments may be implemented in other systems where values required to perform an action are to be determined based on dialogue.

The term “utterance” is to be understood herein as an uninterrupted sequence of words. An utterance may be input as text by the user, or spoken, in which case the system includes a conversion module to convert the speech to text. In the context of the embodiments, a dialogue consists of alternating utterances by the user and provided by a computerised agent.

An API consists of stored protocols and routines for using the external system. An API routine name identifies a single routine that can be called. An invocation of that routine relates to a specific call to that routine and includes specific values for parameters of the routine that are passed to the routine.

For instance, the routine “Freeze” may be used to access a subscription management system to freeze a subscription, and take two parameters: “Magazine”, relating to the specific magazine (such as “Sport” for the Sports Magazine or “Art” for the Arts Magazine) and “Duration”, relating to the time frame to freeze the subscription for (such as “Month” for a single month, “Quarter” for three months or “Year” for a full year). An API call invocation may result from a GUI (graphical user interface) call. For instance, when manipulating the GUI, a user may select a specific magazine and time duration from drop-down menus, and click a “freeze subscription” button. This would result in an API call invocation for freezing a subscription. For example, a call for freezing a certain user's Sports Magazine for a month might look like “Freeze(Magazine=Sport, Duration=Month)”, where “Freeze” is the API routine name, and where “Magazine” and “Duration” are the names of the parameters and where “Sports”, and “Month” are the concrete parameter values in the call.

The routine requires values for certain parameters in order to execute the routine, which have to be provided. Accordingly, an API call to the external system for the routine has to identify a value for each of the parameters, as well as typically the routine. Embodiments of the invention relate to a state structure extractor (SSE). The SSE is configured to determine parameters required by the API and also a set of possible values for each of the parameters, using a corpus of API calls data of past calls to the API. Embodiments also relate to a system for determining, based on a dialogue, values for use in performance of an action and determining if required values for the performance of the action have been determined with acceptable certainty.

The SSE is configured to determine, based on the corpus of API calls data to the particular API, a state structure defining dialogue state tracking (DST) slots and possible values for each slot. Each of the slots corresponds to a respective parameter of the routine that was the subject of at least one API call. The possible values for each slot are referred to as the range of that slot. The corpus comprises dialogues and API calls data, where dialogue was between a user and a human agent, and resulted in the human agent causing an API call using parameter values that the human agent determined from the dialogue.

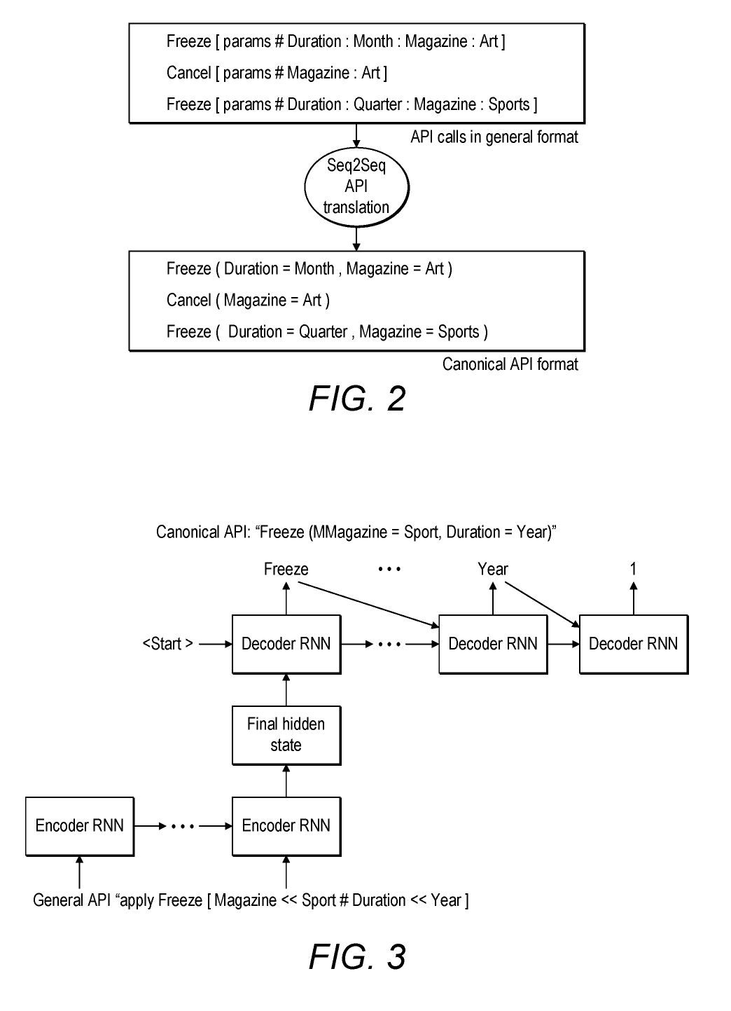

Referring to FIG. 2, the SSE is configured to use a parser, for example a regular expression (“regex”) matching algorithm, to extract parameters and values from the API calls data in the corpus when the API calls data are provided as text strings in a standard format, referred to herein as the “canonical API format”, and to determine the state structure.

However, there are many alternative formats for API calls which could be used; the delimiters may be different, parameters names and their values may be separated by other characters, and so on. For instance, API calls could be given as an XML under some schema, or in a JSON structure. When the API calls data is not provided in the canonical API format, the SSE is configured to convert API calls data into the canonical API as a prior step. This is achieved using a sequencer-to-sequencer conversion module in which the original API call data is input into the model and the canonical API format is output.

The state structure is denoted herein as a tuple R=(S, ƒ), which describes a set of slots to be tracked in a conversation, and values that each slot can take. The set of slots is denoted as S={s₁, . . . sₖ}. For a slot sᵢ, which can take dᵢ different values, different possible values that the slot sᵢ can take are denoted as Vᵢ=v_{i,1}, v_{i,2}, . . . , v_{id}_{ᵢ}. Vᵢ denotes a range of the slots Sᵢ. The state structure, denoted as D, consists of a set S of slots and a function ƒ mapping a slot to the set of values it can take, so D=(S, ƒ), and ƒ(sᵢ)=Vₜ.

In some implementations, in which it may be wanted to indicate the user has not, in the dialogue, expressed a desire or a constraint for a certain slot. In this case, the range of a slot may include an indicator Ø indicating that the user has not yet expressed an intent regarding this slot.

If the user has indicated in the dialogue that any value for a particular slot is acceptable to them, the SSE is configured to assign a value A to that slot indicative of such.

In the canonical format, each API call is represented by a respective routine, in association with each parameter for the routine and a value for each parameter. This may be represented, for example, as

Routine(param₁=v₁;param₂=v₂, . . . ,paramᵤ=vᵤ)

The term “routine” relates to the name of the called routine, “paramᵢ” is the name of the “i” th parameter, and vᵢ is the value passed to this parameter.

For example, given an API data set of the form:

freeze−subscription(duration=month;magazine=art)

freeze−subscription(duration=quarter;magazine=sports)

freeze−subscription(duration=year;magazine=cooking)

The state structure becomes:

action:[freeze−subscription]

duration:[3;7;4]

magazine:[art;sports;cooking]

Formally, given an API routine r, the set of API calls to the routine r in the corpus of API calls is denoted as Aᵣ=(c₁, c₂, . . . , cₙ_{ᵣ}) where nᵣ is the number of times r has been called according to the corpus, and where each cⱼ is an API call of the form r(p₁=y_{j,1}, p₂=y_{j,2}, . . . , pᵤ=y_{j,u}) with u denoting the number of parameters to the routine r, with pⱼ denoting the name of the jth parameter to routine r and with y_{j,k} denoting the concrete value specified to parameter k on the jth call to routine r.

The SSE is configured to create one slot for every parameter. Given a routine r and its set Aᵣ of API calls in the data as defined above, creation of the u slots is denoted (where u is the number of parameters observed in calls to r) as follows:

s_{r,1}:=p₁;s_{r,2}:=p₂, . . . ,s_{r,u}:=pᵤ

where s_{r,j} denotes the j'th slot created for routine r, and where the symbol “:=” is used to denote a creation of a slot (where the name of the slot s_{r,j} is the same as the name for the j'th parameter in the call to routine r).

The SSE is also configured, after creating the slots Sᵣ=(s_{r,1}, s_{r,2}, . . . , s_{r,u}) for routine r, to generate the ranges for each slot. The SSE sets the range for each slot to be a union of all the values observed in the corpus of API calls data. The range generated for slot sₘ (i.e. the range for the m'th slot created for routine r) is denoted by Vₛ_{ᵣ}_{,k}, and is set as follows:

$${V}_{{s}_{r , k}} \text{:=} {⋃}_{j = 1}^{{n}_{r}} \{ {y}_{j , k} \} ⋃ \{ {φ}_{r , k} \}$$

where y_{j,k} denotes the value passed to the k'th parameter in the j'th call to routine r in the corpus of API calls Aᵣ, and where the symbol Ø_{r,k} is a special value indicating that no constraint has yet been specified for parameter k of routine r.

Given a corpus containing API calls over the c routines I=(r₁, r₂, . . . , r_{c}), where routine rᵢ has uᵢ parameters, all the slots can be created for all the routines. Sᵣ_{ᵢ} denotes the set of slots for routine rᵢ, so

$${S}_{{r}_{i} = ( {s}_{{r}_{i} , 1 ,} ,} {s}_{{r}_{i} , 2} , … , {s}_{{r}_{i} , {u}_{i}} ,$$

where sᵣ_{ᵢ}_{,j} relates to the slot created for the j'th parameter of routine rᵢ. The final list of slots consists of all the slots across all the routines:

S=∪_{r∈I}Sᵣ_{ᵢ}=(sᵣ_{₁}_{,1},sᵣ_{₁}_{,2}, . . . ,sᵣ_{₁}_{,u}_{₁},sᵣ_{₂}_{,1},sᵣ_{₂}_{,2}, . . . ,sᵣ_{₂}_{,u}_{₂}, . . . ,sᵣ_{_{c}}_{,1},sᵣ_{_{c}}_{,2}, . . . ,sᵣ_{_{c}}_{,u}_{_{c}})

For each slot j (which relates to some parameter) of each routine rᵢ, a range is generated where Vᵣ_{ᵢ}_{,j} is as discussed above.

The final dialogue state structure is denoted as: D=(S, ƒ) where the slots are S as defined above, and where ƒ(sᵣ_{ᵢ}_{,j})=Vᵣ_{ᵢ}_{,j}.

The trained sequence-to-Sequence (“Seq2Seq”) conversion module is configured to convert previously unobserved API call formats to the canonical format. In an alternative embodiment, an algorithm may be provided configured to convert a specific API call format to the canonical format.

The API calls data in a non-canonical format comprise text, in the form of strings of symbols (including at least letters and numbers). Referring to FIG. 3, the Seq2Seq conversion module includes an encoder configured to receive input of such text and produces a numerical representation of it in the form of a low-dimensional embedding vϵR^{d}, where d is the chosen dimensionality of the embedding. The conversion module also includes a decoder, which processes the embedding to generate an output in the form of the API calls data in a canonical format.

The encoder and decoder have recurrent neural network (RNN) architectures. The RNN may include long short term memory (LSTM) or gated recurrent unit (GRU) cells. Alternatively, a feedforward neural network architecture may be used in place on an RNN architecture, although the outputs may be less accurate particularly for longer sequences.

In an example a set of input symbols is denoted by A, and an input sequence is denoted by (x₁, x₂, . . . , xₙ), where each element is a symbol (i.e. xᵢϵA for all i). Given a required hidden size d, a recurrent neural network (RNN) design iteratively processes the input text to yield a low dimensional embedding hₜϵR^{d} by applying a cell function c: A×R^{d}→R^{d}; the RNN iterates over the equation: hₜ=c(xₜ,hₜ₋₁).

Given the RNN hidden states {hₜ}ₜ₋₁ⁿ an output yₜϵR^{k} (with k denoting the output's dimensionality) is produced at every timestep, by applying a transformation function g:R^{d}⇒R^{k}.

The Seq2Seq conversion module is trained using a historical training set. The historical training set comprises an input sequence, denoted by aᵢ, and an output sequence, denoted by bᵢ. The encoder is referred in the following as RNN E and the decoder is referred to as RNN D. The RNN E is configured to receive an input sequence a=(x₁, . . . , xₙ) and to yield the hidden states (h₁, . . . , hₙ). The final hidden state of the RNN2 hₙ is then copied as the first hidden state of the decoder.

During training the decoder RNN D receives as an input the ground truth output text shifted by one location, b=(s; z₁, . . . , zₙ) (where s is a special start symbol); at every timestep t the decoder yields a decoder hidden state h′ₜ and an output yₜ, where the dimensionality of yₜ is chosen so that yₜ encodes a distribution over the words in a vocabulary. The desired output from the decoder after digesting the t'th ground truth output word zₜ is a probability distribution placing most of the probability mass on the next ground truth word zₜ₊₁.

The encoder and decoder are jointly trained so that once the encoder receives text as input, the decoder will produce the desired output (predicting the next ground truth word at every timestep). A loss function used for training is the sum of the softmax cross entropy losses between the output distribution and the one-hot encoding of the correct word. Given a vocabulary V, the decoder input at time t is denoted as s for t=1 and zₜ₋₁ for t>1, and the decoder output is denoted at time t as yₜ=(rₜ¹, rₜ², . . . , rₜ^{|V|}) This is transformed into a normalized distribution as uₜ=(uₜ¹, uₜ², . . . , uₜ^{|V|}) by applying the softmax operator

$${u}_{i}^{t} = \frac{exp ( {r}_{t}^{i} )}{{\sum }_{j = 1}^{\vert V \vert} exp ( {r}_{t}^{j} )} .$$

The target output word at time t is zₜ, and its “one-hot” encoding is denoted as

α(zₜ)=(αₜ¹, . . . ,αₜ^{|V|})

Where αₜⁱ=1 for i=zₜ and at =1 elsewhere (i.e. if zₜ is the k'th word in the vocabulary, then α(zₜ) is a vector with all coordinates set to 0 except in the k'th location, where it is set to 1). The overall loss is the cross entropy loss between uₜ and α(zₜ) along all the timesteps:

[symbol]

=−Σₜ₌₁ⁿΣᵢ₌₁^{|V|}αₜⁱ log uᵢ^{t}.

The seq2Seq model may be trained by applying a variant of stochastic gradient descent (SGD) backpropagation over a training set consisting of inputs and their ground truth outputs. Training results in setting parameters of the encoder and decoder RNN cells so as to achieve a low loss.

The training data to train the Seq2seq model may be prepared by a human. For example, a state structure may have three slots, and each slot may have 10,000 values. To create the training data, values are sampled to fill their respective slots. A list of different symbols are used as delimiters, parenthesis, etc. These are uniformly sampled to create the structure of each x. The targets (y) may be simultaneously created with each x, by simply placing the slots and values in a constant canonical format. The x's and y's are illustrated in FIG. 2.

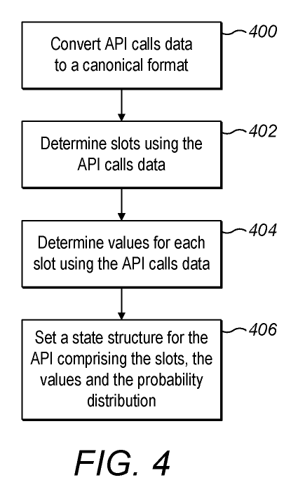

Referring to FIG. 4, operation of the SSE is now described. At step 400, the API calls data is converted from its original format to the canonical format, where the API calls data is initially in a non-canonical format. The API call data, that is, the data indicative of routine, parameters and values, at least, for each API is input into the encoder RNN, is processed, and is then output by the decoder in the canonical format. Some API formats may not include names for parameters. In this case a name is assigned.

At step 402, the SSE determines slots for the or each routine using the API calls data in the canonical format. This is achieved by scanning the calls data and identifying the parameters of each routine, and creating and storing a slot for a parameter each time that a new parameter is identified.

At step 404, the SSE determines a set of possible values for each slot, that is, the range of each slot. This is achieved by scanning the values in the API calls data for each parameter and, each time a new value is found, storing the value in association with the slot for that parameter.

The system comprises a DST and a decision module in the form of a “strategy network”. The DST is configured to receive the state structure and a dialogue as inputs and to predict values for each slot in a state structure. The DST is configured to output a prediction for each slot, yielding an element:

T=Vᵣ_{₁}_{,1}×Vᵣ_{₁}_{,2}× . . . ×Vᵣ_{₁}_{,u}_{₁}×Vᵣ_{₂}_{,1}×Vᵣ_{₂}_{,2}× . . . ×Vᵣ_{₂}_{,u}_{₂}× . . . ×Vᵣ_{_{c}}_{,1}×Vᵣ_{_{c}}_{,2}× . . . ×Vᵣ_{_{c}}_{,u}_{_{c}}

where “x” denotes a Cartesian product. A probability distribution

$${\prod }_{{s}_{{r}_{i} , j}}^{ }$$

is required for each slot sᵣ_{ᵢ} ⱼ, rather than a single value from the range Vᵣ_{ᵢ} ⱼ of the slot (where Vᵣ_{ᵢ} ⱼ is determined by the SSE). The DST system produces a distribution

$${\prod }_{{s}_{{r}_{i} , j}}^{ }$$

and the mode of this distribution is output as the prediction (or the value; indicating no constraint if the distribution fails the tests described below). Thus, any element of the set T is a valid possible DST output.

The strategy network is configured to use the values predicted by the DST and to determine whether a routine can be executed or if more information is needed. The the DST and the strategy network, and their operation, are described in detail in the following.

The system is coupled to a dialogue system, for example a chatbot engine. Components of a dialogue system may include an automatic speech recognition module (for cases where the dialogue is voice based rather than chat based), a natural language understanding unit for obtaining semantic information for utterances or parts of the conversation (name identification, part of speech tagging, semantic parsing), a dialogue manager which keeps the history and state of the dialogue and manages the flow of the conversation, and an output generator which produces utterances for continuing the conversation. Detailed description of the dialogue system is outside the scope of this description. The dialogue system may be a chatbot.

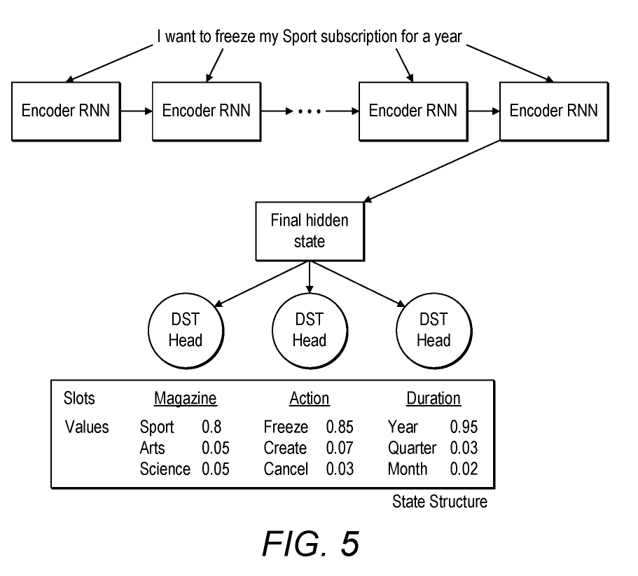

Referring to FIG. 5, an architecture of the DST comprises a recurrent neural network (RNN) and a DST head for every slot.

The RNN is configured to receive an utterance and to output a dense numerical vector representation of the utterance in a latent space. For example, the RNN may be a bidirectional long-short term memory (LSTM) RNN.

Each such DST head is configured to receive the numerical vector representation produced by the RNN, and to output a prediction regarding the correct value for the slot. Each DST head is in the form of a simple classifier; for example each DST head may be configured to classify the vector using a logistic regression to output a probability distribution over the range of each slot in the state structure, or use a feedforward neural network configured to receive the vector and to output the probability distribution. Alternatively, other kinds of classifier may be used.

Preferably, the dialogue is processed by the DST immediately following receipt of a new utterance from the user. This means that the conversation need only continue for the least time necessary, since the dialogue can be ended after the strategy network determines that there is sufficient information to execute a routine. However, the DST can also receive as inputs a prefix of a conversation, or an entire conversation, C.

Before it can be used, the DST is trained using the API calls data. This is the same API calls data from which the state structure was extracted by the SSE, although, to train the DST, dialogue associated with each API call from that API calls data is also used. The data consists of pairs (g; s) where g is a text representing a conversation or a part of it, and where s is a belief-state structure adhering to the state structure (i.e. s assigns a value for every slot from the range of that slot)

The training set uses conversations along with their API call invocation. A conversation c is a sequence of utterances, denoted as uᵢ, and API call invocations, denoted as aᵢ. For instance, a possible conversation could be c=(u₁, u₂, u₃, u₄, a₁, u₅, u₆, a₂, u₇, u₈) (where locations 1, 2, 3, 4 are utterances, location 5 is an API call invocation, locations 6 and 7 are utterances, location 8 is an API call invocation and locations 9 and 10 are utterances). t(c) denotes the set of indices where an API call occurs, so in the above example we have t(c)={5, 8}. pᵢ(c) denotes a prefix of the conversation up until (but not including) index i; for instance, in the above example p₅(c)=(u₁, u₂, u₃, u₄) and p₈(c)=(u₁, u₂, u₃, u₄, a₁ u₅, u₆). For a set of indices J, we denote by P_{J} (c) the set of all conversation prefixes up until each of the indices in J (i.e. every prefix of c ending in an index from J). Thus, P_{t(c)}(c) is the set of prefixes ending in (but not including) API calls (and in the previous example, P_{t(c)}(c)={p₅(c), p₈(c)}.

At every point in a conversation where an API call is executed, we can obtain a ground-truth supervision for the correct belief-state at that point in the conversation, by converting the API call invocation to its canonical format and extracting the passed parameter values as described above. For every API call invocation a occurring in an index j of a conversation c a training instance (g, s) where g=Pⱼ(c) (the prefix up until the API call), and where s is the belief-state 5 In extracted from the API call invocation. Thus, for a conversation c containing multiple API call invocations, we generate multiple training instances with the prefixes P_{t(c})(c) along their respective belief-states. By applying this process to all the conversations in the training set, the DST training set is obtained.

Following the training, the DST can receive as an input a previously unobserved conversation (or part of a conversation) and predict the correct value for each slot.

Preferably, both the encoder RNN and DST heads are trained simultaneously. The loss of a single DST head is a softmax cross-entropy, the standard classifier loss. The overall loss of the network is the sum of the losses across all the slots (the sum of the DST head losses). Co-training the encoder and DST heads makes the network generate a latent embedding that is expressive with respect to slot values (and to ignore information that does not pertain to any of the slots).

By way of specific example, the encoder may be a bidirectional RNN with LSTM cells, and each DST head may be a small feedforward network with one hidden layer. The DST head for a slot S with a range V may have the form:

$${h}_{1} = {c}_{enc} ( {u}_{1} , {i}_{enc} )$$

$${h}_{t} = {c}_{enc} ( {h}_{t - 1} , {u}_{t} )$$

$${π}_{i}^{′} = σ ( {W}_{i} {h}_{T} + {b}_{i} )$$

$${π}_{i} = \frac{exp ( {π}_{i}^{′} )}{{\sum }_{j - 1}^{\vert V \vert} exp ( {π}_{j}^{′} )}$$

In the above equations, c_{enc} is an RNN cell such as an LSTM cell, hᵢ is the i'th hidden state of the encoder network, which is digesting a text sequence consisting of T utterances denoted (u₁, u₂, . . . , u_{T}); Wᵢ is a parameter weight matrix for slot i of dimension d×|Vᵢ| (with d denoting the hidden layer size of the RNN cell), and where σ(x) denotes the sigmoid function

$$σ ( x ) = \frac{exp ( x )}{1 + exp ( x )} .$$

The output Πs=(π₁, π₂, . . . , π_{|V|}) forms a normalized distribution over the range V of the slot s.

The softmax cross entropy function may be used to calculate the loss for a single head for the slot s using:

$${L}_{g , s} = - {\sum }_{i = 1}^{\vert V \vert} {y}_{g , i} log {π}_{g , i}$$

The index g above relates to the training instance g, so π_{g,i} is the distribution associated with the i'th value for the slot s when feeding in the training instance g, and where y_{g,i} is an indicator variable denoting the ground truth value for the slot (i.e. y_{g,i}=1 for the value i which is the correct value for the slot s on the training instance g, and y_{g,i}=0 otherwise). The overall loss for the DST network is the sum of the head losses across all slots (and across the fed training instances):

$$L = {\sum }_{g ∈ G} {\sum }_{s ∈ S} {L}_{g , s}$$

where G denotes the training instances used for the training procedure, and where S is the set of all tracked slots.

During training, model parameters may be iteratively tuned after examining mini-batches of training set instances, by applying backpropagation, for example by stochastic gradient descent with an Adam optimizer.

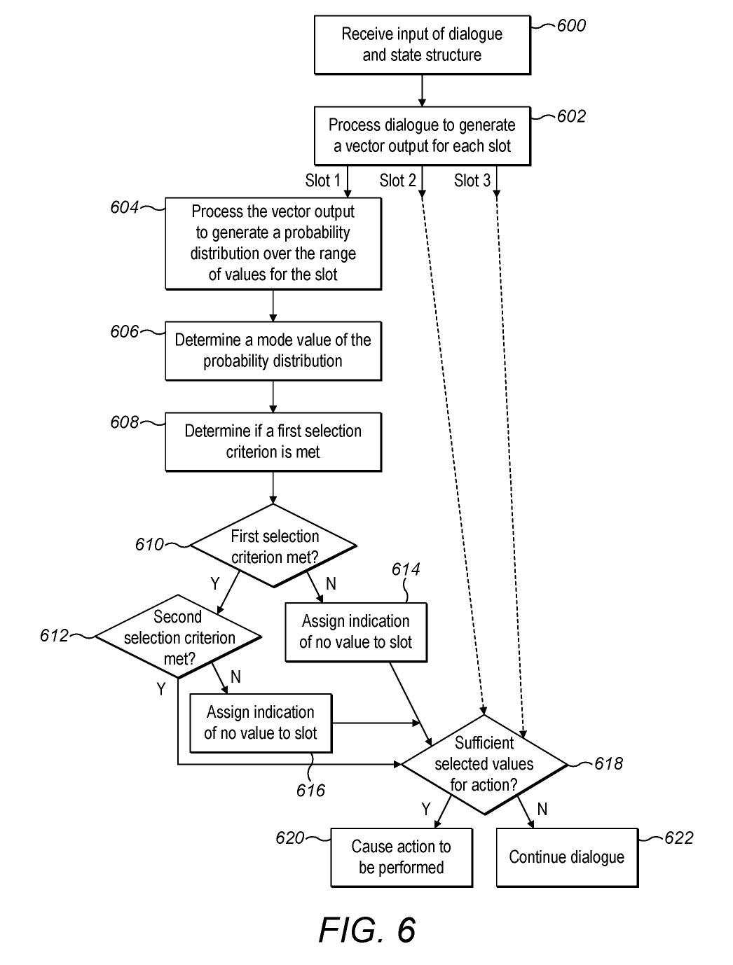

The DST system, for a state structure R=(S, ƒ) takes an input a conversation, as indicated at 600 in FIG. 6 or a part of the conversation, and outputs a representation vector for each slot at step 602. Preferably, the state structure used by the DST system is generated using the SSE, as described above, although in alternative embodiments the DST may receive a state structure prepared by a human domain expert in place of the state structure generated by the SSE.

The DST head then processes the representation vector to generate a probability distribution over the range of that slot at 604. Thus, given a conversation C, for every sentence in the conversation, for every slot sᵢ the DST outputs a probability distribution πᵢ over the range of sᵢ, i.e. list of values:

(πᵢ(v_{i,1}),πᵢ(v_{i,2}), . . . ,πᵢ(v_{i,d}_{ᵢ}))

Where, for any j∈{1, 2, . . . , dᵢ}, π_{i,j}(v_{i,j})≥0 and for any slot sᵢ we have Σⱼ₌₁^{di}πᵢ(v_{i,j})=1

The DST then determines a mode of the probability distribution for each slot at step 606.

The DST then determines whether a first selection criterion is met for the mode value for each of the slots at step 608 and 610, to determine if the mode value has been determined for the slot with an acceptable degree of certainty. If the probability distribution for the slot is heavily weighted towards a particular one of the possible values for a slot, this value is determined to be the correct one for the slot (proceed to step 612); if the probability distribution is spread across several of the possible values, indicated by not having an obvious “peak” for the model's output probability distribution, the DST system determines that a value has not been determined for the slot. In this case, an indication of no value is assigned to the slot (step 614).

The purpose of applying the first selection criterion is to address a problem that the DST's RNN and the DST head have been trained with the API data sets where values have been specified for all slots, and thus have not been trained with data sets where a value is unspecified. Accordingly, the DST will not make a prediction that a value the slot is unspecified.

The first selection criterion requires examining the distribution to determine that it places significant mass on the mode value, so maxⱼ₌₁^{d}^{ᵢ}πᵢ(v_{i,j})≥α for a parameter α. The value maxⱼ₌₁^{d}^{ᵢ}πᵢ(v_{i,j}) is a proxy for the degree of certainty regarding the correct value for the slot sᵢ. α=0.6, although other values may be used and an optimum value may be determined by experiment. If maxⱼ₌₁^{d}^{ᵢ}πᵢ(v_{i,j})≥α the DST output is set as the value Ø, indicating no constraint was specified for sᵢ yet.

The DST also applies at step 612 a second selection criterion to determine that the reason that the probability distribution is heavily weighted towards a slot is due to the additional information gained after examining the dialogue, rather than information regarding the prior distribution of the values of the slots.

A priori, without even examining the input dialogue to the DST task, some values are more likely to occur than other values for a slot. For instance, referring to the example above, if 80% of the dialogues regarding subscriptions relate to the Sports magazine (and only 20% are regarding other magazines), the magazine slot is far more likely to take the value sport than the other values.

The prior distribution over the possible values can be computed over the possible values {v_{i,1}, v_{i,1}, . . . , v_{i,d}_{ᵢ}} for a slot sᵢ by examining all training instances in the corpus and checking the value that sᵢ takes. Alternatively, the prior distribution can be taken as an even spread over all possible values for a slot. We denote by Tₛ_{ᵢ}₌ᵥ_{_{i,j}} all the instances in the corpus where sᵢ takes the value v_{i,j}, which are all the API call invocations where slot sᵢ takes the value v_{i,j}. q_{i,j} is used to denote the proportion of training instances where sᵢ takes the value v_{i,j}, that is:

$${q}_{i , j} = \frac{\vert {T}_{{s}_{i} = {v}_{i , j}} \vert}{{\sum }_{k = 1}^{{d}_{i}} \vert {T}_{{s}_{i} = {v}_{i , k}} \vert}$$

The prior distribution over the values slot sᵢ can take is denoted as Qᵢ=(q_{i,1}, q_{i,2}, . . . , q_{i,d}_{ᵢ}). After examining an input conversation (or prefix of a conversation), the DST, produces a posterior distribution over the values for slot sᵢ, denoted Πᵢ=(πᵢ(v_{i,1}), πᵢ(v_{i,2}), . . . , πᵢ(v_{i,d}_{ᵢ})).

Determining whether the second selection criterion is met requires examining the degree to which the posterior distribution differs from the prior distribution Q by evaluating the Kullback-Leibler divergence D_{KL}(Πᵢ∥Qᵢ) between them. The Kullback-Leibler divergence D_{KL}(Πᵢ∥Qᵢ) is a measure of the amount of information gained in the posterior model distribution Πᵢ relative to the prior probability distribution Qi, and is defined as:

$${D}_{KL} ( {Π}_{i} \vert \vert {Q}_{i} ) = {\sum }_{j = 1}^{{d}_{i}} {Π}_{i} ( {v}_{i , j} ) log ( \frac{{Π}_{i} ( {v}_{i , j} )}{{q}_{i , j}} )$$

A high the value of D_{KL}(Πᵢ∥Qᵢ) indicates that the prior and posterior distributions are very different, indicating that the reason for the certainty for the value of sᵢ is the dialogue; a low value indicates that the reason for the certainty is the information known a priori, with the dialogue contributing little to no new information. If D_{KL}(Πᵢ∥Qᵢ<β for some threshold parameter β, the A value of β=0.05 has been used in inventor experiments.

If both the first and second selection criterion are met, so both maxⱼ₌₁^{d}^{ᵢ}πᵢ(v_{i,j})≥α and D_{KL}(Πᵢ∥Qᵢ)≥β, the mode of the Π distribution is output as the predicted value for slot sᵢ, i.e. the prediction for this slot being v_{i,k} where k=argmaxⱼ₌₁^{d}^{ᵢ}πᵢ(v_{i,j})

In an embodiment, the prior distribution may be uniform, so

$${Q}_{i} = ( \frac{1}{{d}_{i}} , \frac{1}{di} , … , \frac{1}{di} ) ,$$

every value for this slot is equally likely a priori and the divergence value is:

$${D}_{KL} ( {Π}_{i} \vert \vert {Q}_{i} ) = {\sum }_{i ∈ {V}_{i}} {Π}_{i} log ( \frac{{Π}_{i}}{\frac{1}{{d}_{i}}} ) = {\sum }_{i ∈ {V}_{i}} {Π}_{i} ( log {d}_{i} + log {Π}_{i} ) = {\sum }_{i ∈ {V}_{i}} {Π}_{i} log {Π}_{i} + log {d}_{i} \cdot {\sum }_{i ∈ {V}_{i}} {Π}_{i}$$

As Π is a probability distribution over the values Vᵢ that the slot can take

$${\sum }_{i ∈ {V}_{i}} {Π}_{i} = 1$$

$${D}_{KL} ( {Π}_{i} \vert \vert {Q}_{i} ) = {\sum }_{i ∈ {V}_{i}} {Π}_{i} log {Π}_{i} + log {d}_{i} = - {\sum }_{i ∈ {V}_{i}} {Π}_{i} log \frac{1}{{Π}_{i}} + log {d}_{i} = log {d}_{i} - H ( {Π}_{i} ) where H ( {Π}_{i} )$$

denotes the Shannon entropy of the distribution Πᵢ.

In variant embodiments, other ways of determining a divergence value may be used in determining whether one of the values should be selected for a slot from the range of possible values for that slot. Other selection criteria may also be used generally.

If the second selection criterion is met, the selected value for the slot is passed to the strategy network. Otherwise, an indication of that a value has not bee assigned is allocated to the respective slot at step 616.

The strategy network is configured to determine whether a routine can be executed based on the determined values and either to cause an action relating to the routine, such as invocation of an API call to that routine, or to cause the dialogue system to continue the dialogue with the user. Such an action may simply be communication to a human agent of the determined values and that the routine is able to be executed.

A routine may require values to have been determined by the DST system for all of the parameters of the routine. As described above, one or more slots may have an indication in the form of a value Ø, indicating that no value is assigned to the slot. If a routine requires a slot to have a value and the value for that slot is Ø, then that routine cannot be performed and further dialogue is required.

Alternatively, values may be essential for some parameters and not others, and in this case the strategy network is configured to determine that the routine can be executed if essential values are output from the DST system.

In a variant embodiment, the strategy network may determine whether each of at least two routines can be executed based on the determined values. In this case, the strategy network can be configured to cause execution of any one or more of the routines for which required values are output by the DST system, and optionally instruct the dialogue system to continue the dialogue with the user. Alternatively, if the strategy network causes execution of any routine, or any particular one or more routines, the strategy network may also be configured to instruct the dialogue system that there is no more need for information and the dialogue can thus be ended.

The strategy network may be configured to determine whether any of the slots for which values are required by the routine can be executed using algorithms.

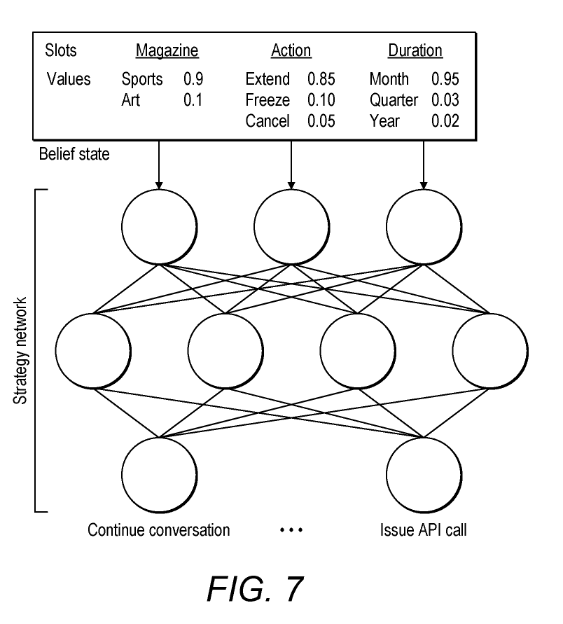

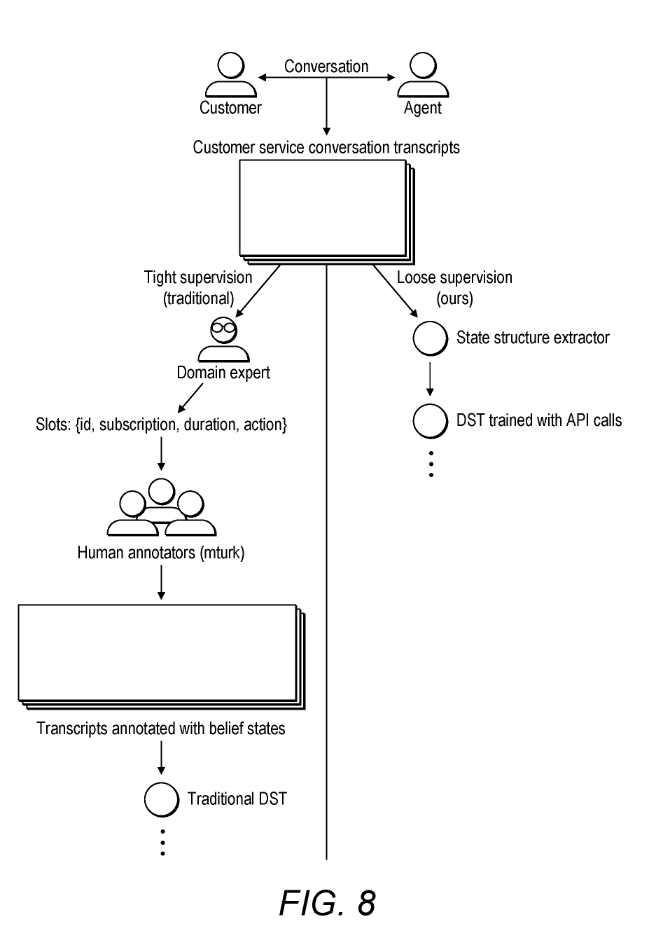

In the embodiment indicated in FIG. 7, the strategy network is a neural network configured to receive as an input the probability distributions generated by the DST and to determine whether values have been determined for predetermined slots, such that a routine can be executed and thus an API call can be invoked. Use of a neural network means that the strategy network does not have to be configured with information on which parameters of the one or more routines, or which combinations thereof, are essential in order for the one or more routines to be executed. In the case of m routines, the neural network is designed to have m+1 output neurons, denoted t=(t₀, t₁, t₂, . . . , tₘ), where t₀ relates to not invoking an API call (and further conversing with the customer), and where t, relates to executing rᵢ, the i'th routine. The inputs to the neural network are the DST outputs, denoted as a=(a₁, a₂, . . . , a_{w}). The number of inputs is the product of all the slot sizes, i.e. w=Πᵢ₌₁^{k}dᵢ where dᵢ denotes the number of elements in the range of slot sᵢ.

The neural network is a feedforward neural network, although other kinds of neural network may be used. For instance, an implementation with one hidden layer would be applying a linear transformation followed by a sigmoid non-linearity to get the hidden layer h=α(W₁a+b₁), then applying another linear transformation followed by a sigmoid nonlinearity to obtain the outputs h=σ(W₂a+b₂), where W₁, W₂ are matrix parameters and b₁, b₂ are vector parameters to be learned during training. The loss of this neural network is the softmax cross-entropy loss with the ground truth (the identity of the executed routine, or the value specifying that no routine was called), similarly to the loss of the DST heads.

The neural network is configured with an output to indicate that there is insufficient values for the routine to be performed, and an output to indicate that there are the required values for the routine. Where more than one routine may be called, there may be an output corresponding to each routine. The strategy network is configured to indicate to the dialogue system if dialogue with the user should be continued. If the conversation state is not properly constrained, then the conversation agent continues the dialogue with the customer, asking for information until the missing constraints are filled. Formally, the strategy network is denoted by y=softmax(V·O^{T}+b)

where V is a weight vector of length

$${\sum }_{i = 1}^{size ( S )} size ( {V}_{i} ) ,$$

and b,y∈IR, and softmax is the softmax operator over some vector v, producing v′:

$${v}_{i}^{′} = \frac{exp ( {v}_{i} )}{{\sum }_{j = 1}^{size ( {V}_{i} )} exp ( {v}_{j} )}$$

where v′=[v′₁, . . . , v′ₘ] is a probability distribution.

Referring again to FIG. 6, at step 618 the strategy network determines whether a routine should be executed and, if so, which one. If a routine r is to be executed, the DST slots relating to the parameters of the routine r are examined. If a constraint (value) is specified for a parameter, it is passed to the routine, and if no value is specified (i.e. the DST output is Ø, for that slot), the parameter is not passed to the routine. If sufficient values have been determined so that the routine can be performed, an API invocation module (not shown) may then invoke an API call at step 620. Otherwise, at step 622, the strategy network signals to the dialogue system to continue the dialogue with the user.

Given the context of the conversation and outputs from the DST, the strategy network infers whether the state space is properly constrained i.e. if the system has learned enough information from the user to issue an API call.

The neural network can be trained by taking historical conversations and creating a training instance qᵤ=(a,t) for every utterance u in each such conversation. If an API call was not executed following the utterance u, the correct SN output t is conversing (not invoking an API call), and if an API call was executed, it is the identity of the executed routine. The training instance's input a is the DST's belief-state following the utterance u (i.e. the belief-state after the DST ingesting the prefix of the conversation ending with the utterance u). The SN can then be trained using backpropagation (applying stochastic gradient descent), similarly to the DST neural network.

The processes described above are implemented by computer programs. The computer programs comprise computer program code. The computer programs are stored on one or more computer readable storage media and may be located in one or more physical locations.

The computer programs may be implemented in any one or more of a number of computer programming languages and/or deep learning frameworks, for example Pytorch, TensorFlow, Theano, DL4J. When run on one or more processors, the computer programs are configured to enable the functionality described herein.

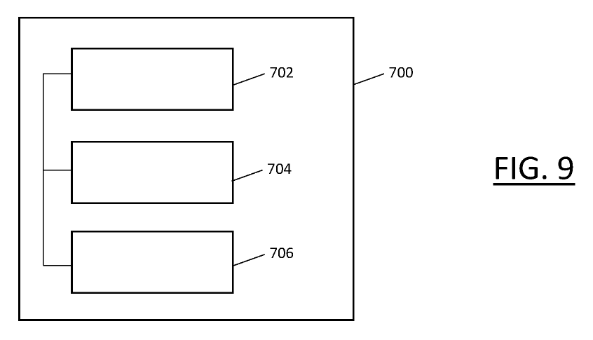

As will be apparent to a person skilled in the art, the processes described herein may be carried out by executing suitable computer program code on any computing device suitable for executing such code and meeting suitable minimum processing and memory requirements. For example, the computing device may be a server or a personal computer. Some components of such a computing device are now described with reference to FIG. 9. In practice such a computing device will have a greater number of components. The computer system 700 comprises a processor 702, computer readable storage media 704 and input/output interfaces 706, all operatively interconnected with one or more busses. The computer device 700 may include a plurality of processors or a plurality of computer readable storage media 704, operatively connected. The input/out interfaces 706 allow coupling of input/output devices, such as a keyboard, a pointer device, a display, et cetera.

The processor 702 may be a conventional central processing unit (CPU). The processor 702 may be a CPU augmented by a graphical processing unit (GPU) to speed up training. Tensor processing units (TPU) may also be used. The computer readable storage media 704 may comprise volatile and non-volatile, removable and non-removable media. Examples of such media include ROM, RAM, EEPROM, flash memory or other solid state memory technology, optical storage media, or any other media that can be used to store the desired information including the computer program code and to which the processor 702 has access.

As an alternative to being implemented in software, the computer programs may be implemented in hardware, for example GPU, CPU or special purpose logic circuitry such as field programmable gate array or an application specific integrated circuit such as a TPU. Alternatively, the computer programs may implemented in a combination of hardware and software.

Embodiments of the invention are not limited to use with any particular kind of API. The API may be, for example, a web API or a Java API.

It will be appreciated by persons skilled in the art that various modifications are possible to the embodiments.

The applicant hereby discloses in isolation each individual feature or step described herein and any combination of two or more such features, to the extent that such features or steps or combinations of features and/or steps are capable of being carried out based on the present specification as a whole in the light of the common general knowledge of a person skilled in the art, irrespective of whether such features or steps or combinations of features and/or steps solve any problems disclosed herein, and without limitation to the scope of the claims. The applicant indicates that aspects of the present invention may consist of any such individual feature or step or combination of features and/or steps. In view of the foregoing description it will be evident to a person skilled in the art that various modifications may be made within the scope of the invention.

1. A method comprising:
receiving input of a dialogue;
processing the dialogue by a neural network based system, to output, for each of a plurality of slots, a probability distribution over a range of values associated with the respective slot, the neural network based system being trained using a training dataset comprising a plurality of dialogues and, for each dialogue, a value corresponding to each slot, wherein each dialogue resulted in an action;
determining, based at least on the probability distribution for each slot, if an action requiring a value for at least some of the slots can be performed;
if not, causing continuing of the dialogue.

2. The method of claim 1, wherein the determining if the action can be performed comprises:
determining, for each slot, if one of the values can be selected based at least on the probability distribution and at least one selection criterion;
determining if the action can be performed at least based also on a result of the determining if one of the values can be selected for each slot.

3. The method of claim 2, further comprising:
for each of the slots for which a value can be selected, selecting the value for the slot; and
if the required values are selected, causing the action to be performed using the selected values.

4. The method of claim 3, wherein, for each slot, if a result of the determining is that no value can be selected for a slot, associating an indication that no value can be selected with the slot.

5. The method of claim 3, wherein the selecting the values for the slots comprises selecting the mode value of the probability distribution for the respective slot.

6. The method of claim 5, wherein the at least one selection criterion comprises determining if the probability distribution indicates that a probability score for the mode value meets a requirement for the extent to which the probability score for the mode value is greater than the probability score for other of the values.

7. The method of claim 2, wherein the at least one selection criterion comprises:
determining, for each slot, a prior distribution of the values for that slot in the training dataset;
determining, for each slot, a divergence value indicative of divergence of the probability distribution from the prior distribution;
comparing the divergence value to a predetermined threshold value;
determining that one of the values can be selected based on a result of the comparing.

8. The method of claim 7, wherein the determining, for each slot, the divergence value, comprises evaluating the Kullback-Leibler divergence between the prior distribution and the probability distribution.

9. The method of claim 1, wherein the action has parameters, and each slot corresponds to a respective one of the parameters.

10. The method of claim 9, wherein the determining if an action requiring at least some of the values can be performed comprises determining if a value is selected for each of the slots.

11. The method of claim 10, wherein the action comprises an API routine.

12. The method of claim 11, wherein the training dataset comprises API calls data comprising the plurality of dialogues, for each dialogue, information indicative of each parameter, and, for each parameter a respective value, each of the values was recorded by a human agent when such a value was known to the human agent from the corresponding dialogue, and the human agent invoked an API call to the corresponding routine.

13. The method of claim 1, wherein the neural network based system comprises a recurrent neural network component and, for each slot, a respective classifier, wherein the processing the input dialogue comprises:
generating word representation vectors for the dialogue;
inputting the vectors into the recurrent neural network component, and outputting a further vector for each slot;
processing, for each slot, the respective further vector, using the respective classifier, to generate the probability distribution for the values of the respective slot.

14. The method of claim 3, wherein the determining, for each slot, if an action requiring at least one of the values can be performed comprises:
inputting a selected value or an indication that a value cannot be selected for each slot to a decision module;
determining, by the decision module, to perform at least one of: causing the action to be performed, and the causing continuing of the dialogue by a non-person agent.

15. The method of claim 1, further comprising:
determining, using the training dataset, the slots;
determining possible values for each of the slots;
setting the determined values for each slot as a range for that slot.

16. The method of claim 1, further comprising:
trained the neural network based system using the training dataset comprising a plurality of dialogues and, for each dialogue, the value corresponding to each slot, wherein each dialogue resulted in the action in the form of an API call invocation.

17. A system comprising:
a neural network based system configured to:
receive input of a dialogue;
process the dialogue by a neural network based system;
output, for each of a plurality of slots, a probability distribution over a range of values associated with the respective slot, the neural network based system being trained using a training dataset comprising a plurality of dialogues and, for each dialogue, a value corresponding to each slot, wherein each dialogue resulted in an action;
a decision module configured to: determine, based at least on the probability distribution for each slot, if an action requiring a value for at least some of the slots can be performed;
if not, causing continuing of the dialogue.

18. A computer program product comprising computer program code stored on a computer readable storage medium, wherein, the computer program code is configured to, when run on a processing unit, perform the steps of:
receiving input of a dialogue;
processing the dialogue by a neural network based system, to output, for each of a plurality of slots, a probability distribution over a range of values associated with the respective slot, the neural network based system being trained using a training dataset comprising a plurality of dialogues and, for each dialogue, a value corresponding to each slot, wherein each dialogue resulted in an action;
determining, based at least on the probability distribution for each slot, if an action requiring a value for at least some of the slots can be performed;
if not, causing continuing of the dialogue.

19. The computer program product of claim 18, wherein the determining if the action can be performed comprises:
determining, for each slot, if one of the values can be selected based at least on the probability distribution and at least one selection criterion;
determining if the action can be performed at least based also on a result of the determining if one of the values can be selected for each slot.

20. The computer program product of claim 19, further comprising:
for each of the slots for which a value can be selected, selecting the value for the slot; and
if the required values are selected, causing the action to be performed using the selected values.
